(19) United States
(12) Patent Application Publication
(10) Pub. No.: US 2008/0063406 A1
(43) Pub. Date: Mar. 13, 2008

(54) DATA TRANSMISSION APPARATUS

(75) Inventors: Junji KAZAMA, Tokyo (JP); Satoru SUZUKI, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION, Tokyo (JP)

(21) Appl. No.: 11/852,882

(22) Filed: Sep. 10, 2007

(30) Foreign Application Priority Data
Sep. 11, 2006 (JP) 2006-245529
Feb. 2, 2007 (JP) 2007-024118

(51) Int. Cl. H04B 10/00

(52) U.S. Cl. 398/140

(57) ABSTRACT

Disclosed is a data transmission apparatus including: a measurement data obtaining section to obtain a measurement data signal from a measuring object; a data processing section to perform data processing of the measurement data signal; and a data transmitting section, intervened between the measurement data obtaining section and the data processing section, to transmit the measurement data signal to the data processing section in an electrically insulated state, wherein the data transmitting section includes: a surface emitting laser diode to convert the measurement data signal into an optical signal; a receiving optical device to receive the optical signal from the surface emitting laser diode; and an optical waveguide type transmission path, disposed between the surface emitting laser diode and the receiving optical device, to transmit the optical signal.

### BACKGROUND OF THE INVENTION

1. Field of the Invention

The present invention relates to a data transmission apparatus, and more particularly, to a data transmission apparatus using a technique of data transmission between an input section and a data processing section in a measuring instrument, and still more particularly to a data transmission apparatus using an insulation technique which is preferable to measurement of a voltage waveform (voltage waveforms of a high voltage and an extremely low voltage).

2. Description of Related Art

In a measuring instrument used for measurement of a voltage waveform of a high voltage exceeding several hundreds voltage [V] and a voltage waveform of an extremely low voltage less than one milli voltage [mV], electrical insulation between a measurement data obtaining section (input section), which obtains a measurement data signal, and a data processing section, which performs the data processing of the obtained measurement data signal, is important.

For example, in the measurement of a high voltage waveform, insulation enables the securement of the protection of the data processing section side and safety of a user. Moreover, in the measurement of an extremely low voltage waveform, insulation enables the reduction in the influence of noise of a common mode voltage because very high measurement accuracy is required.

Moreover, the importance of the insulation is true not only in the case of voltage measurement, but also in the measurement of an electric current, resistance, pressure, temperature, and the like. It is desired to transmit these signals in an insulated state from the point of view of the protection of a measuring instrument and the improvement of measurement accuracy.

FIG. 5 shows an example of a conventional digital data transmission apparatus 10. As shown in FIG. 5, a measurement data obtaining section 2 and a data processing section 3 are mounted on a same board 1. The measurement data obtaining section 2 and the data processing section 3 are mutually connected through data insulating transmission sections 6, 7, and 8, and a measurement data signal is transmitted to the data processing section 3 in a state of being electrically insulated by the data insulating transmission sections 6, 7, and 8.

The measurement data obtaining section 2 includes an A/D converter 4, which converts a measurement analog data signal (Ain) obtained through a probe, or the like, into a digital data signal (Din). Parallel data signals outputted from the A/D converter 4 are transmitted to the data insulating transmission sections 6, 7, and 8 through a plurality of data lines 5.

The data processing section 3 is composed of a field programmable gate array (FPGA) 9 and the like. The FPGA 9 performs predetermined operation processing of the data signals transmitted through the data insulating transmission sections 6, 7, and 8, and the EPGA 9 instructs to display the result of the processing, and the like.

Conventionally, as the data insulating transmission sections 6, 7, and 8, a photo coupler, a high-speed isolator, an insulating transformer, and the like, are generally used. If these devices are used as the data insulating transmission sections 6, 7, and 8, the maximum limit of the data transmission speed thereof is about 100 Mbps.

On the other hand, the data insulating transmission sections 6, 7, and 8 are desired to have high withstand voltage characteristics when high withstand voltage measurement is performed. In order to achieve the high withstand voltage, a desired withstand voltage can be obtained by setting the distance (hereinafter, the distance is referred to as “insulation distance”), which is necessary for insulating between the measurement data obtaining section 2 and the data processing section 3, to be sufficiently long.

Since the photo coupler and the high-speed isolator are standardized in sizes of their elements and packages to some extent, the improvement in the withstand voltage has limitations. Accordingly, there is disclosed a circuit configuration capable of clearly specifying a voltage applied to a direct-current input terminal with respect to the ground, which had been difficult for the insulated transmission structures by the conventional photo coupler and the high-speed isolator, by using the insulating transformer and including an oscillating circuit (see, Japanese Patent Application Laid-Open Publication No. 2005-18550).

However, even if the insulating transformer is used for the data insulating transmission sections 6, 7, and 8, the transmission speed thereof has limitations similarly to the photo coupler or the high-speed isolator. Moreover, there arises a new problem that the measuring instrument is getting larger in size.

### SUMMARY OF THE INVENTION

It is, therefore, a main object of the present invention to provide a data transmission apparatus capable of increasing transmission speed, realizing high withstand voltage and miniaturization.

According to one aspect of the present invention, there is provided a data transmission apparatus, comprising: a measurement data obtaining section to obtain a measurement data signal from a measuring object;

a data processing section to perform data processing of the measurement data signal; and

a data transmitting section, intervened between the measurement data obtaining section and the data processing section, to transmit the measurement data signal to the data processing section in an electrically insulated state, wherein

the data transmitting section includes:

a surface emitting laser diode to convert the measurement data signal into an optical signal;

a receiving optical device to receive the optical signal from the surface emitting laser diode; and

an optical waveguide type transmission path, disposed between the surface emitting laser diode and the receiving optical device, to transmit the optical signal.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a block diagram of a data transmission apparatus according to a preferred first embodiment of the present invention;

FIG. 2 is a schematic view of a data transmitting section in the data transmission apparatus;

FIG. 3A is an external view of an optical signal transmission path;

FIG. 3B is a sectional view of the optical signal transmission path;

FIG. 4 is a block diagram of a data transmission apparatus according to a preferred second embodiment of the present invention; and

FIG. 5 is a schematic view of a conventional digital data transmission apparatus.

### DESCRIPTION OF THE PREFERRED EMBODIMENTS

In the following, a configuration and operation according to preferred embodiments of a data transmission apparatus of the present invention will be described in detail with reference to the attached drawings. The same reference number will be used to refer to the same component or corresponding component throughout the figures for convenience. The description below will be given mainly to differences from the related art.

### First Embodiment

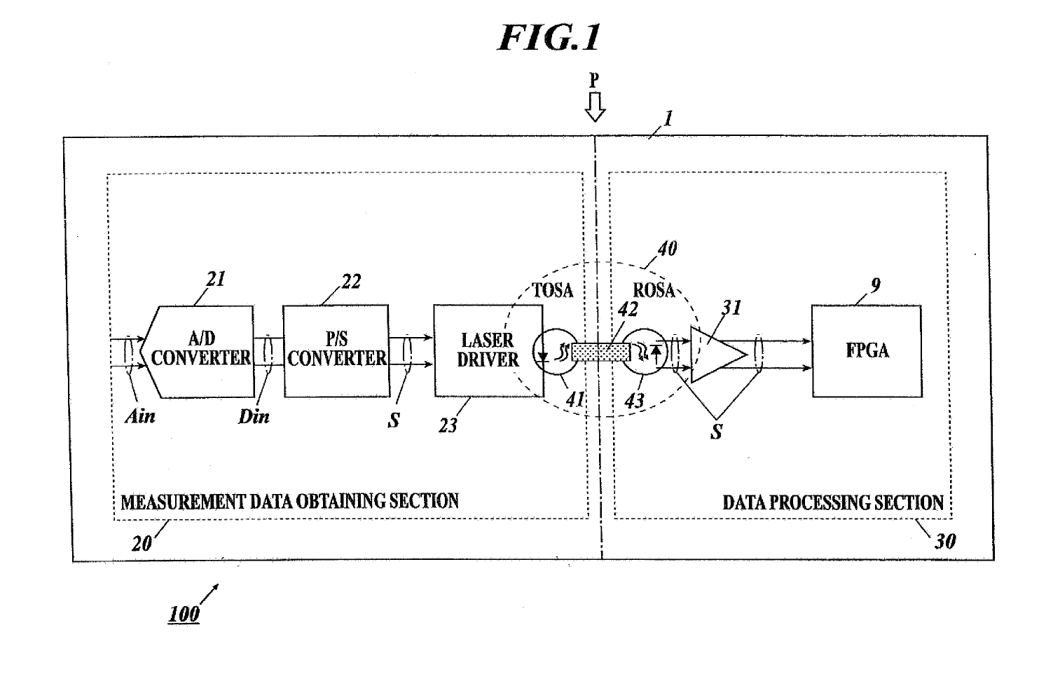

FIG. 1 shows an example of a data transmission apparatus 100 according to a first embodiment. The data transmission apparatus 100 mainly includes a measurement data obtaining section 20, a data processing section 30, and a data transmitting section 40, and these components are disposed on a same board 1.

The measurement data obtaining section 20 includes an A/D converter 21, a P/S converter 22, and a laser driver 23. The A/D converter 21 converts an analog data signal (Ain) inputted from a measuring object into a digital data signal (Din). Signals inputted from the measuring object may be signal waveforms such as a resistance waveform, a pressure waveform, and a temperature waveform besides a voltage waveform and a current waveform. The Din converted by the A/D converter 21 is converted by the P/S converter 22 into a serial digital data signal (“signal S” compatible with a high speed transmission). The laser driver 23 is a driver for driving Transmitter Optical Sub-Assembly (TOSA) 41 for associating the signal S outputted from the P/S converter 22 with an optical signal (TOSA 41 will be described later).

The P/S converter performs the conversion adopting the Low Voltage Differential Signaling (LVDS) method or the Current Mode Logic (CML) method, both of which covert a parallel signal into a low-voltage differential serial signal to transmit the converted serial signal. The transmission method by the LVDS or the CML enables a high speed transmission with a few signal lines in comparison with single end transmission, which transmits a data signal through only one signal line.

The data transmitting section 40 includes the TOSA 41, an optical waveguide type optical signal transmission path 42, and a receiver optical sub-assembly (ROSA) 43. The TOSA 41 includes a vertical cavity surface emitting laser (VCSEL) which emits light by using an electric signal inputted through the laser driver 23. An optical signal outputted from the TOSA 41 is transmitted in an insulated state through the optical signal transmission path 42. The ROSA 43 receives the optical signal transmitted through the optical signal transmission path 42.

The TOSA 41 and the ROSA 43 are optical transceivers in conformity with Gigabit Ethernet (registered trademark) or the Fiber Channel standard. The VCSEL is used in a transmission section, TOSA 41. A photodiode is used in a reception section, ROSA 43. The VCSEL has a property of emitting light perpendicularly to a wafer surface, and is superior in cost because of low power consumption and mass production and the like in comparison with a conventional edge emitting laser (semiconductor laser), which emits light parallel to a wafer surface of a semiconductor chip.

The optical signal transmission path 42 has material that enables the measurement data obtaining section 20 and the data processing section 30 to keep an electrically insulated state and allows light to transmit by total internal reflection. For example, the material corresponds to a flat surface type optical waveguide, an optical fiber of a three-dimension type optical waveguide, and the like. In the present embodiment, the optical fiber, from which a jacket and the like are removed to leave a core and a cladding, is held with a ferrule, but the material is not limited to this. Any insulation material can be applied as long as the material can transmit data signals as mentioned above.

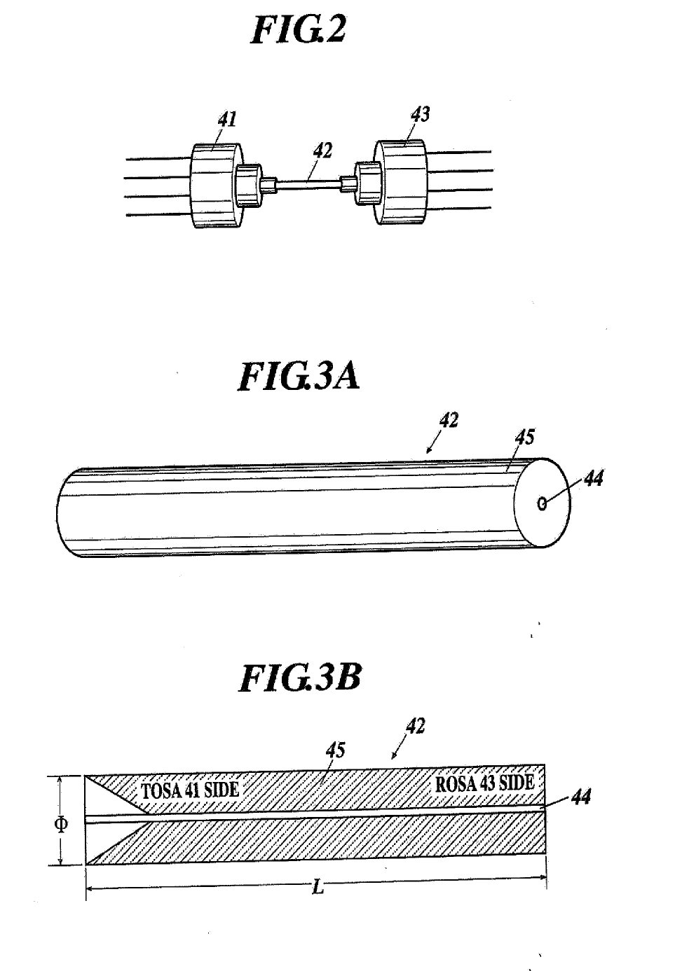

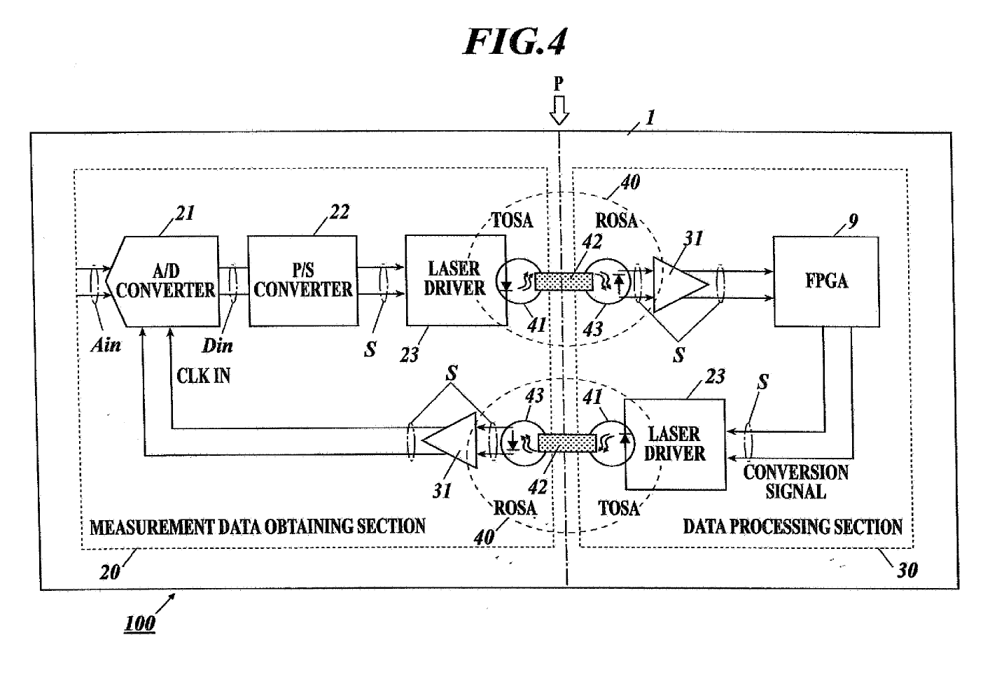

Now, the optical fiber and the ferrule, which are insulated transmission members used in the present embodiment, will be described with reference to FIGS. 2, 3A, and 3B.

FIG. 2 shows a schematic view of the data transmitting section 40 in the data transmission apparatus 100 of the present embodiment. In the optical signal transmission path 42 of the present embodiment, a distance L between the measurement data obtaining section 20 and the data processing section 30 being L=about 20 mm to about 30 mm. Therefore, the use of a multimode optical fiber especially enables a high speed data transmission and reduction in loss of transmission owing to the influence of bending and the like. A graded-index (GI) type multimode optical fiber capable of high speed transmission, which is generally widely used, may be used as the multimode optical fiber.

FIG. 3A shows an external view of the optical signal transmission path 42 of the present embodiment, and FIG. 3B shows a sectional view of the optical signal transmission path 42. The optical signal transmission path 42 is composed of an optical fiber 44 and a ferrule 45 covering the optical fiber 44. The ferrule used here has a length L, which has been described in the explanation of FIG. 2, and a diameter (Φ) of 1.25 mm. The ferrule is compatible with an LC connector. Moreover, any insulation material, such as zirconia, ceramic, and plastic, can be used as the material of the ferrule. Using the ferrule which is easily detachable to the current TOSA 41 and the ROSA 43 enables simplification of a manufacturing process, handling, and the like.

Returning to FIG. 1, the data processing section 30 includes an amplifier section 31 and a FPGA 9. The amplifier section 31 is a limiting amplifier for giga-hertz communication, the limiting amplifier enabling high speed transmission by raising voltage level of an electric signal received from the ROSA 43 when the electric signal is extremely infinitesimal.

The FPGA 9 receives the signal S that has been transmitted at a high speed through the amplifier section 31. The FPGA 9 performs various kinds of processing, such as an operation processing of the data inputted into the measurement data obtaining section 20 and displaying the result of the processing, and the like.

As described above, according to the first embodiment, it is possible to increase the transmission rate in an insulated state by using the TOSA 41 with a built-in VCSEL, the ROSA 43, and the optical signal transmission path 42 with the ferrule 45 connecting the TOSA 41 and the ROSA 43. Moreover, low power consumption by the use of the VCSEL, miniaturization of the apparatus due to serial transmission, and high withstand voltage by changing the length of the ferrule arbitrarily can be achieved. Furthermore, it is possible to eliminate harmful effects (causing enlargement in size of the apparatus owing to difficulty in process, generating loss by the influence of bending, and the like) in the case of using only the optical fiber, by holding the optical fiber with ferrule.

The data transmission apparatus 100 of the first embodiment has been described in the above. The description of the first embodiment includes one example of a data transmission apparatus according to the present invention, but is not limited to this explanation. It will be apparent that various changes may be made without departing from the scope of the invention. For example, in FIG. 1, by separating the measurement data obtaining section 20 and the data processing section 30 at a separable position P on the board 1, each of them can be arranged on separate boards. This makes it possible to heighten level of certainty of insulation function and to increase degree of freedom of board arrangement. Consequently, various design changes can be made.

Moreover, in FIGS. 2, 3A, and 3B, the whole optical fiber 44 is disposed inside one ferrule 45 to hold the optical fiber 44. Instead of this configuration, only both ends of the optical fiber 44 may be held with separate ferrules without holding middle portion of the optical fiber 44 (in the vicinity of the separable position P). Therefore, the convenience in manufacturing process and modification work can be achieved.

### Second Embodiment

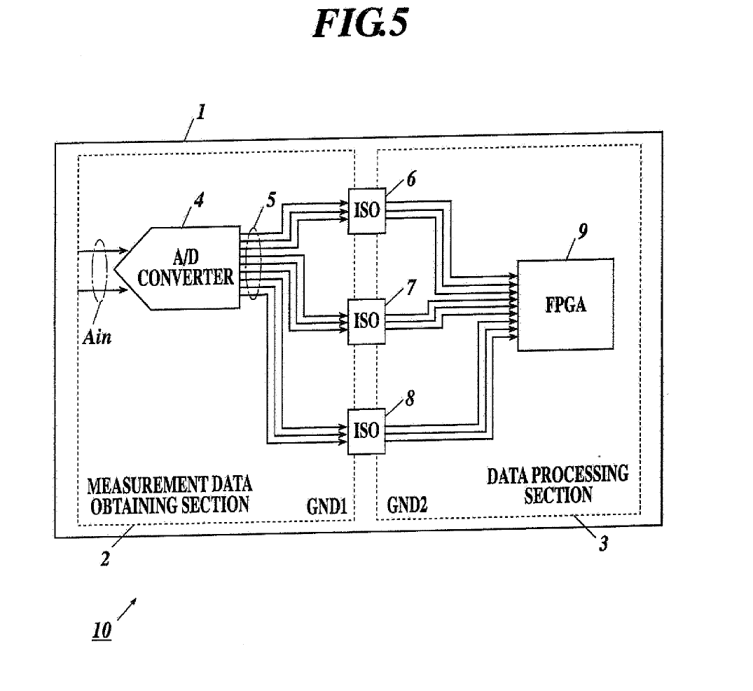

FIG. 4 shows an example of the data transmission apparatus 100 in the case of using a couple of the data transmitting sections 40 as a second embodiment of the present invention. The data transmission apparatus 100 mainly includes the measurement data obtaining section 20, the data processing section 30, and a couple of data transmitting sections 40, all of which are arranged on the same board 1. Since principal configurations of the measurement data obtaining section 20, the data processing section 30, and the data transmitting sections 40 are similar to those of the above-described first embodiment, their descriptions will be omitted here. Only the configuration between the FPGA 9 and the A/D converter 21, which is different from the configuration of the first embodiment, will be described in the following.

The FPGA 9 outputs signals for making the A/D converter 21 operate properly to a laser driver 23 equipped in the data processing section 30. The signals outputted from the FPGA 9 toward the A/D converter 21 are mainly a clock (CLK) signal and a conversion (CNV) signal. The CLK signal is for supplying a clock necessary for each section. The CNV signal is a conversion starting signal for making the A/D converter 21 start an A/D conversion.

The CNV signal, which is inputted into the A/D converter 21, is used as a trigger to start transmitting measurement data from the A/D converter 21 toward the FPGA 9 in synchronization with the CLK signal.

The CLK signal and the CNV signal outputted from the FPGA 9 are inputted into the data transmitting section 40 through the laser driver 23. The CLK signal and the CNV signal are transmitted between the data processing section 30 and the measurement data obtaining section 20 in an insulated state by using an optical communication technique of the TOSA 41 and the ROSA 43, which are included in the data transmitting section 40. After that, the CLK signal and the CNV signal are inputted into the A/D converter 21 through an amplifier section 31. Incidentally, if the A/D converter 21 cannot deal with a differential input, a not-shown differential/single converter may be arranged on an input side of the A/D converter 21.

As described above, according to the second embodiment, the data transmitting section 40 is used for the transmission of the CLK signal and the CNV signal. This makes it possible to speed up the data transmission without arranging a plurality of data insulating transmission sections (a photo coupler or the like) for keeping high speed transmission. In particular, an insulated transmission can be achieved through one optical signal transmission path 42. Hence, miniaturization of the apparatus and various changes of circuit design can be made. Moreover, if the A/D converter 21 having a high sampling frequency is used to improve a processing speed, no delay of the CNV signal to the CLK signal occurs because the CNV signal can be speeded up by optical transmission. Consequently jitter can be suppressed to enable high-accuracy processing. Incidentally, the example of using a couple of data transmitting sections 40 has been described in the second embodiment, but the number of the data transmitting sections 40 is not limited to the two. A plurality of data transmitting section 40 may be used in the data transmission apparatus 100.

According to one aspect of the preferred embodiments of the present invention, there is provided a data transmission apparatus, comprising: a measurement data obtaining section to obtain a measurement data signal from a measuring object; a data processing section to perform data processing of the measurement data signal; and a data transmitting section, intervened between the measurement data obtaining section and the data processing section, to transmit the measurement data signal to the data processing section in an electrically insulated state, wherein the data transmitting section includes: a surface emitting laser diode to convert the measurement data signal into an optical signal; a receiving optical device to receive the optical signal from the surface emitting laser diode; and an optical waveguide type transmission path, disposed between the surface emitting laser diode and the receiving optical device, to transmit the optical signal.

The data transmission apparatus enables high speed transmission by using the surface emitting laser as a light emitting element of the data transmitting section. Moreover, it is possible to set an insulation distance arbitrarily by using the optical waveguide type transmission path. Therefore, in the measurement of signals having extremely large amplitude or infinitesimal amplitude (such as voltage, current, resistance, pressure, and temperature), the enhancement of the withstand voltage and the reduction in noise can be achieved. Furthermore, the surface emitting laser, which is capable of high speed transmission, enables low power consumption without arranging a plurality of data insulating transmission sections in parallel to each other like the related art.

Preferably, the measurement data obtaining section includes: an analog-to-digital converter to convert the measurement data signal into a digital data signal; and a parallel-to-serial converter to convert the digital data signal into a serial data signal and to output the serial data signal to the surface emitting laser diode.

The data transmission apparatus can achieve simplification of wiring and the miniaturization of a product because of the serial transmission.

Preferably, the optical waveguide type transmission path includes: an optical fiber to transmit the optical signal; and a ferrule to hold the optical fiber.

The data transmission apparatus uses the optical fiber which transmits the optical signal, and the ferrule which holds the optical fiber, as the optical waveguide type transmission path. This makes it possible to achieve reduction in cost in a manufacturing process and miniaturization of the product by modification work.

Preferably, the data transmitting section is capable of bidirectional transmission of the optical signal between the data obtaining section and the data processing section.

The data transmission apparatus can transmit a signal bi-directionally between the data obtaining section and the data processing section in an insulated state. Thereby, it is possible to transmit a signal that is controlling conversion starting timing of the A/D converter (a conversion signal) at a high speed without arranging a plurality of data insulating transmission sections like the related art. Since the conversion signal can be transmitted at a high speed, jitter (fluctuation in frequency) does not become larger even if a clock frequency becomes higher. Therefore, the measurement data can be processed at a high speed and in high accuracy.

Preferably, the data obtaining section, the data processing section, and the data transmitting section are mounted on a same board.

According to the data transmission apparatus, the data obtaining section, the data processing section, and the data transmitting section are mounted on a same board. Such structure enables the mounting of definite components in a small space and the realization of electrical insulation.

Preferably, the data obtaining section and the data processing section are mounted on separate boards.

According to the data transmission apparatus, the data obtaining section and the data processing section are mounted on separate boards. Thereby, the effect of the insulation and the withstand voltage can be achieved more completely in comparison with the case where both the sections are mounted on the same board. Moreover, various design changes can be made because the degree of freedom of board arrangement increases.

The entire disclosures of Japanese Patent Application No. 2006-245529 filed on Sep. 11, 2006 and Japanese Patent Application No. 2007-024118 filed on Feb. 2, 2007 including description, claims, drawings and summary are incorporated herein by reference in their entireties.

Although various exemplary embodiments have been shown and described, the invention is not limited to the embodiments shown. Therefore, the scope of the invention is intended to be limited solely by the scope of the claims that follow.

What is claimed is:

1. A data transmission apparatus, comprising:
a measurement data obtaining section to obtain a measurement data signal from a measuring object;
a data processing section to perform data processing of the measurement data signal; and
a data transmitting section, intervened between the measurement data obtaining section and the data processing section, to transmit the measurement data signal to the data processing section in an electrically insulated state, wherein
the data transmitting section includes:
a surface emitting laser diode to convert the measurement data signal into an optical signal;
a receiving optical device to receive the optical signal from the surface emitting laser diode; and
an optical waveguide type transmission path, disposed between the surface emitting laser diode and the receiving optical device, to transmit the optical signal.

2. The data transmission apparatus according to claim 1, wherein
the measurement data obtaining section includes:
an analog-to-digital converter to convert the measurement data signal into a digital data signal; and
a parallel-to-serial converter to convert the digital data signal into a serial data signal and to output the serial data signal to the surface emitting laser diode.

3. The data transmission apparatus according to claim 1, wherein
the optical waveguide type transmission path includes:
an optical fiber to transmit the optical signal; and
a ferrule to hold the optical fiber.

4. The data transmission apparatus according to claim 1, wherein the data transmitting section is capable of bidirectional transmission of the optical signal between the measurement data obtaining section and the data processing section.

5. The data transmission apparatus according to claim 1, wherein the measurement data obtaining section, the data processing section, and the data transmitting section are mounted on a same board.

6. The data transmission apparatus according to claim 1, wherein the measurement data obtaining section and the data processing section are mounted on separate boards.
